(19) United States
(12) Patent Application Publication
(10) Pub. No.: US 2012/0056723 A1
(43) Pub. Date: Mar. 8, 2012

(54) METHOD AND SYSTEM FOR BAGGAGE CLAIM AT THE AIRPORT

(76) Inventor: LIPING ZHU, SAN JOSE, CA (US)

(21) Appl. No.: 13/225,153

(22) Filed: Sep. 2, 2011

Related U.S. Application Data
(60) Provisional application No. 61/380,315, filed on Sep. 6, 2010.

(30) Foreign Application Priority Data
Nov. 25, 2010 (CN) 201010569065.X

(51) Int. Cl. G06K 7/01

(52) U.S. Cl. 340/10.1

(57) ABSTRACT

The present invention provides a method and system for baggage claim at the airport. The method includes when an RFID claim tag taken along by a passenger gets close to an RFID reader, the RFID reader reading the RFID claim tag and obtaining baggage claim information; searching corresponding baggage identification information according to the baggage claim information; searching corresponding baggage according to the baggage identification information; and conveying the baggage to a designated place according to the baggage claim information. The present invention enables the passenger to claim his baggage conveniently and quickly.

### CROSS-REFERENCE TO RELATED APPLICATIONS

This application claims priority of U.S. provisional application No. 61/380,315, filed on Sep. 6, 2010, entitled “Airport Baggage Claim Process and System”, and Chinese Patent Application No. 201010569065.X, filed on Nov. 25, 2010, entitled “Method and System for Baggage Claim at the Airport”, which are incorporated herein by reference in their entireties.

### FIELD OF THE TECHNOLOGY

The present invention relates to a method and a system for baggage claim at the airport, belonging to the technical field of management of baggage at the airport.

### BACKGROUND

In the prior passenger aviation service, after a passenger arrives at his destination, he will go to baggage claim zone to claim his baggage consigned before boarding a flight. The prior baggage claim method is that: when the passenger consigns his baggage, the airline binds the baggage with a baggage identification card with bar codes. In addition, the boarding card of the passenger is also attached with a baggage claim card with corresponding bar codes, and the baggage can be identified according to the bar codes on a tag.

The problems of the prior technique are that: as a passenger cannot read bar codes, he can only find his baggage through its appearance. However, as some baggages have similar appearance, it is difficult for the passenger to find out his own baggage quickly and accurately. Moreover, the passenger may even pick up a wrong baggage sometimes.

### SUMMARY

The invention provides a method and a system for baggage claim at the airport so as to enable a passenger to claim his own baggage conveniently and quickly.

In one aspect, the present invention provides a method for baggage claim at the airport. The method includes:

When an RFID (Radio Frequency Identification) claim tag taken by a passenger gets close to an RFID reader, the RFID reader reads the RFID claim tag and then obtains baggage claim information;

According to the baggage claim information, the corresponding baggage identification information can be found out;

According to the baggage identification information, the corresponding baggage can be found out;

According to the baggage claim information, the baggage is conveyed to a designated place.

In another aspect, the present invention provides a system for baggage claim at the airport. The system includes:

An RFID claim tag, which is taken along by a passenger;

An RFID reader, which is used for reading the RFID claim tag and obtains baggage claim information;

An information searching unit, which is used for searching corresponding baggage identification information according to the baggage claim information read by the RFID reader;

A baggage searching unit, which is used for searching corresponding baggage according to the baggage identification information found by the information searching unit;

A baggage conveying unit, which is used for conveying the baggage to a designated place according to the baggage claim information found by the baggage searching unit.

### BRIEF DESCRIPTION OF THE DRAWINGS

In order that embodiments of the invention or the technical proposals in the prior art are illustrated more clearly, the drawings needed in the embodiments or the prior art are introduced briefly as follows. It is apparent that the drawings in the description are some embodiments of the invention. The persons skilled in the art can obtain other drawings according to these drawings without any creative work.

FIG. 1 is a flow chart of Embodiment 1 of a method for baggage claim at the airport of the present invention.

FIG. 2 is a flow chart of Embodiment 2 of a method for baggage claim at the airport of the present invention.

FIG. 3A and FIG. 3B are two optional flow charts of Embodiment 3 of the method for baggage claim at the airport of the present invention.

FIG. 4 is a structural view of Embodiment 1 of a system for baggage claim at the airport of the present invention.

FIG. 5 is a partial structural view of Embodiment 2 of a system for baggage claim at the airport of the present invention.

### DETAILED DESCRIPTION

In order that the purposes, technical proposals and advantages of embodiments of the present invention become clearer, together with the drawings and the embodiments of the present invention, the technical proposals of the embodiments of the invention are described more clearly and completely below. It is obvious that the described embodiments are only part of embodiments of the present invention but are not all of the embodiments. Based on the Embodiments of the invention, all of other embodiments obtained by the persons skilled in the art without any creative work are within the scope protected by the invention.

FIG. 1 is a flow chart of Embodiment 1 of a method for baggage claim at the airport of the present invention. As shown in FIG. 1, the method includes:

Step 110: when an RFID claim tag taken along by a passenger gets close to an RFID reader, the RFID reader reads the RFID claim tag and obtains baggage claim information.

The baggage claim information includes baggage identification information to be claimed. The baggage identification information is the information that can uniquely identify the baggage and has one-to-one correspondence with corresponding baggage claim information. For example, the baggage identification information may be set to be an odd number value and the corresponding baggage claim information is set to be an even number value which is the odd number value plus one. Specifically, the baggage claim information can be saved in a memory in the RFID claim tag.

Step 120: the corresponding baggage identification information is searched according to the baggage claim information.

The RFID reader can search the corresponding baggage identification information from its own stored baggage identification information according to the baggage claim information; or if there are many baggages and a large quantity of baggage identification information, the RFID reader can also send the baggage claim information to a baggage management server which searches the corresponding baggage identification information from its own stored baggage identification information according to the baggage claim information.

Step 130: the corresponding baggage is searched according to the baggage identification information.

Specifically, the baggage identification information can also include baggage own property information such as weight, appearance, color, etc. or include the ownership information such as passport number, visa information, etc. of the passenger as the baggage owner, or include the photos of the baggage. Therefore, the place of the corresponding baggage can be positioned quickly.

In some cases, if the passenger is short of necessary clearance procedure documents, the customs officers need to take out the corresponding baggage which is prohibited to be conveyed at a plane to guarantee the safety of a flight. Therefore, according to the baggage photos and the passenger's passport number contained in the baggage identification information, the customs officers can check the corresponding baggage conveniently.

Step 140: the baggage is conveyed to designated places according to the baggage identification information.

For example, the baggage can be conveyed to the place where the passenger completes customs clearance procedure so that the passenger can claim his baggage conveniently, thereby saving waiting time; or according to the baggage claim information, the connecting flight information of flight of the passenger is searched, and then according to the connecting flight information, the baggage is conveyed to the connecting flight which the passenger is going to take, thereby reducing the trouble of the baggage of midway conveying of the passenger. In addition, according to the baggage claim information, the address information pre-stored by the passenger is searched, and according to the address information, the baggage is conveyed to the corresponding place, for example, the hotel he will stay or family residence, etc.

The method of the present embodiment can enable a passenger to claim his own baggage conveniently and quickly.

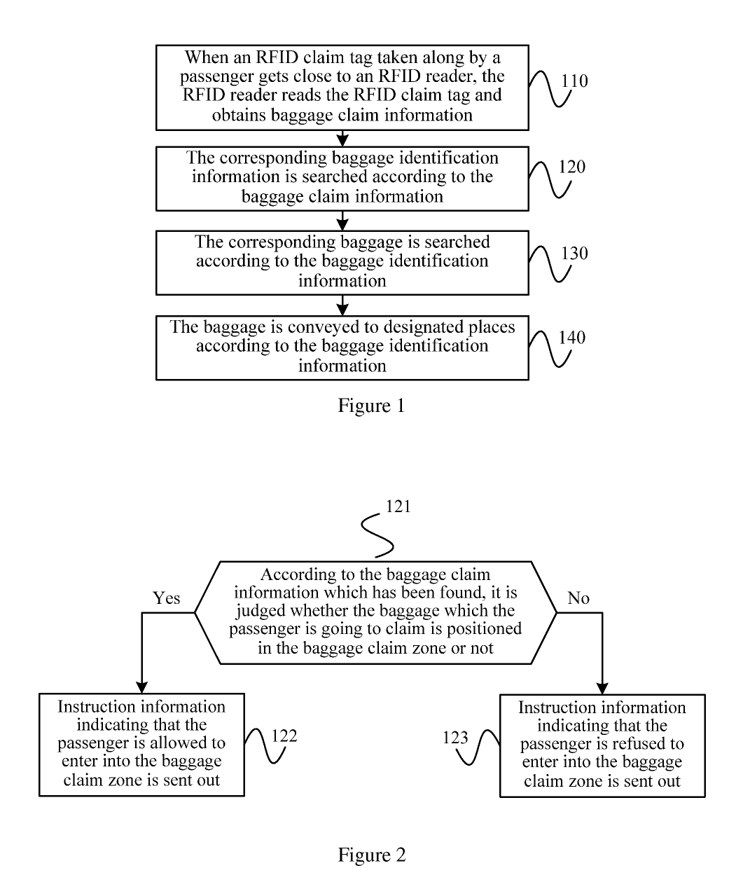

FIG. 2 is a flow chart of Embodiment 2 of a method for baggage claim at the airport of the present invention. In the present Embodiment, the RFID reader is provided at an entry of a baggage claim zone. When the RFID claim tag taken along by the passenger gets close to the entry, the RFID reader reads the RFID claim tag and obtains the baggage claim information.

As shown in the figure, after the corresponding baggage identification information is searched according to the baggage claim information in the abovementioned Step 120, the method of the present embodiment can further include the following steps:

Step 121: according to the baggage claim information which has been found, it is judged whether the baggage which the passenger is going to claim is positioned in the baggage claim zone or not. If the answer is yes, Step 122 is carried out; otherwise, Step 123 is carried out.

Step 122: instruction information indicating that the passenger is allowed to enter into the baggage claim zone is sent out.

For example, a green light is turned on to allow the passenger to enter into the baggage claim zone.

Step 123: instruction information indicating that the passenger is refused to enter into the baggage claim zone is sent out.

For example, a red light is turned on or whistle is blown so that the passenger is refused to enter into the baggage claim zone.

The method of the present embodiment can identify whether the baggage which the passenger is going to claim is positioned at the baggage claim zone where the passenger has arrived; therefore, under the conditions that there are a plurality of baggage claim zones at the airport, the passenger can be avoided to enter a wrong baggage claim zone, thereby saving the passenger's time, contributing to prevent the baggage from being claimed wrongly and then guaranteeing the safety of baggage.

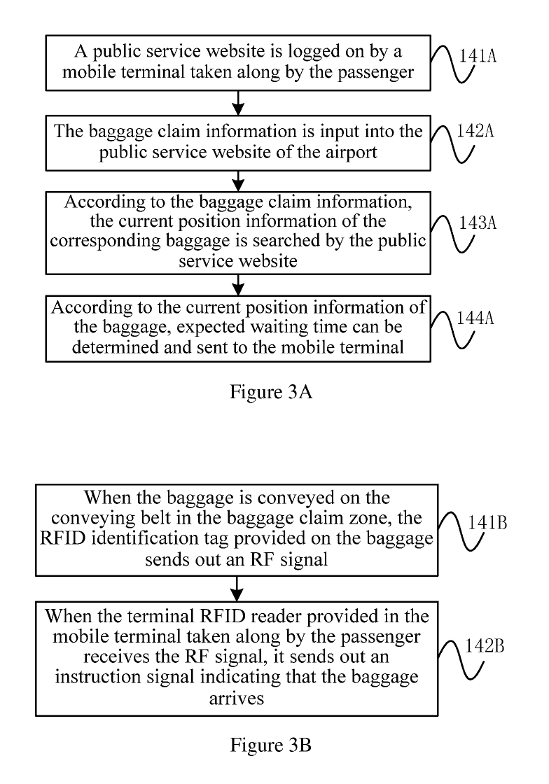

FIG. 3A and FIG. 3B are two optional flow charts of Embodiment 3 of the method for baggage claim at the airport of the present invention. As shown in the figures, in the present embodiment, specifically, Step 140 is that: according to the baggage claim information, the baggage is conveyed to the baggage claim zone.

As an RFID reader is provided at an entry of the baggage claim zone, when the RFID claim tag taken along by the passenger gets close to the entry, the RFID reader can obtain the baggage claim information on the RFID claim tag, so that a baggage conveying system can know which baggage claim zone the baggage shall be conveyed to.

As shown in FIG. 3A, before the baggage is conveyed to the baggage claim zone, the following steps can be carried out:

Step 141A: a public service website is logged on by a mobile terminal taken along by the passenger.

Specifically, the mobile terminal can access to a background server of network through the WiFi (Wireless Fidelity) network arranged in the airport, and log on the public service website of the airport.

Step 142A: the baggage claim information is input into the public service website of the airport.

Step 143A: according to the baggage claim information, the current position information of the corresponding baggage is searched by the public service website.

As for the RFID identification tag provided on the baggage in this step, during the baggage is conveyed on a conveying belt, the RFID reader at the periphery of the conveying belt can read the RF signal sent by an RFID identification tag, so that the current position of the baggage can be determined. As the baggage claim information in the present embodiment has one-to-one correspondence with the baggage identification information, the corresponding baggage identification information can be found out through the baggage claim information so that the current position information of the corresponding baggage can be found out.

Step 144A: according to the current position information of the baggage, expected waiting time can be determined and sent to the mobile terminal.

With the step, through a mobile terminal, the passenger can know how long it will take for baggage to arrive at the baggage claim zone. If he needs to wait a relatively long time, he may have a short rest or deal with other matters, thereby contributing him to arrange his own time reasonably. In addition, if the passenger does not want to wait for the baggage as it takes a relatively long time to arrive, he may also require related service personnel to convey his baggage to hotel or home, thereby saving waiting time.

As shown in FIG. 3B, after the baggage is conveyed to the baggage claim zone, the following steps can be carried out:

Step 141B: when the baggage is conveyed on the conveying belt in the baggage claim zone, the RFID identification tag provided on the baggage sends out an RF signal.

Step 142B: when the terminal RFID reader provided in the mobile terminal taken along by the passenger receives the RF signal, it sends out an instruction signal indicating that the baggage arrives.

Specifically, the instruction signal indicating that the baggage arrives can be a signal such as a whistle signal or a vibration signal. When the mobile terminal of the passenger sends out the instruction signal indicating that the baggage arrives, he knows that his baggage will arrive soon. At this time, he can fetch his baggage on the conveying belt.

With the method in the present embodiment, the passenger can know the time of baggage arrival in time, thereby enabling him to arrange his time reasonably and reducing waiting time.

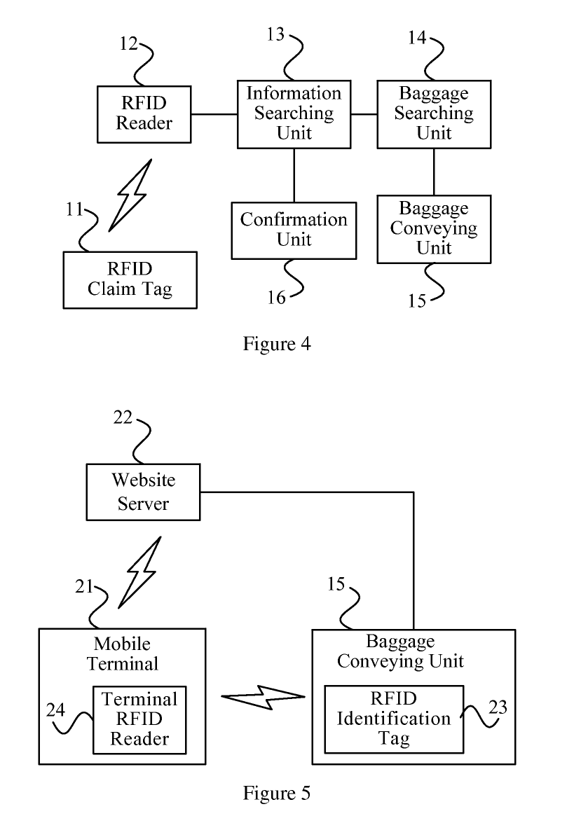

FIG. 4 is a structural view of Embodiment 1 of a system for baggage claim at the airport. As shown in the figure, the system for baggage claim at the airport includes an RFID claim tag 11, an RFID reader 12, an information searching unit 13, a baggage searching unit 14 and a baggage conveying unit 15. Its working principles are as follows:

The RFID claim tag 11 is taken along by the passenger. Specifically, the RFID claim tag 11 can be arranged on a baggage claim card taken along by the passenger or in a mobile terminal taken along by the passenger. When the RFID claim tag 11 taken along by the passenger gets close to the RFID reader 12, the RFID reader 12 reads the RFID claim tag 11 and obtains baggage claim information.

After that, according to the baggage claim information read by the RFID reader 12, the information searching unit 13 searches corresponding baggage identification information. Specifically, the information searching unit 13 can be provided in the RFID reader 12, and search the corresponding baggage identification information from the baggage identification information stored by the RFID reader 12 itself according to the baggage claim information. Or the information searching unit 13 can also be provided in a baggage management server (not shown in figures) at the background, and search the corresponding baggage identification information from the baggage identification information stored in the baggage management server itself according to the baggage claim information.

After that, the baggage searching unit 14 searches corresponding baggage according to the baggage identification information found by the information searching unit 13. Specifically, the baggage identification information may also include property information of the baggage such as weight, appearance, colors, etc. or may include the ownership information such as passport number, visa information, etc. of the passenger as the baggage owner, or may include the photos of the baggage, so as to position the place of the corresponding baggage quickly.

Finally, according to the baggage claim information found by the baggage searching unit 14, the baggage conveying unit 15 conveys the baggage to a designated place. The examples can be found in the relative description of the aforementioned Step 140 in details. It is unnecessary to give more details here.

The system in the present invention can enable the passenger to claim his own baggage conveniently and quickly.

Alternatively, the RFID reader 12 can be provided at an entry of the baggage claim zone (not shown in the figures). The system may further include a confirmation unit 16. According to the baggage claim information found by the information searching unit 13, the confirmation unit 16 judges whether the baggage to be claimed by the passenger is positioned in the baggage claim zone. If the answer is yes, instruction information indicating that the passenger is allowed to enter into the baggage claim zone is sent out, for example, a green light is turned on to allow the passenger to enter into the baggage claim zone; otherwise, instruction information indicating that the passenger is refused to enter into the baggage claim zone is sent out, for example, a red light is turned on or whistle is blown to refuse the passenger to enter into the baggage claim zone

With the added confirmation unit 16, under the conditions that there are a plurality of the baggage claim zones at the airport, the passenger is avoided to enter into a wrong baggage claim zone, thereby saving the time of the passenger, contributing to preventing the baggage from being claimed wrongly and guaranteeing the safety of the baggage.

FIG. 5 is a partial structural view of Embodiment 2 of a system for baggage claim at the airport of the present invention. As shown in the figure, the system also includes a mobile terminal 21 and a website server 22, of which the principles are as follows:

Before the baggage is conveyed into the baggage claim zone by the conveying unit 15, the passenger logs on a website server 22 of a public service website of the airport through his mobile terminal 21, and inputs the baggage claim information. The website server 22 searches the current position information of the corresponding baggage from the baggage conveying unit 15 according to the baggage claim information from the mobile terminal 21, and determines and sends out expected waiting time to the mobile terminal 21 according to the current position information of the baggage.

With the present embodiment, the passenger can know how long it takes for his own baggage to arrive at the baggage claim zone through the mobile terminal 21. If he needs to wait for a relatively long time, he may have a short rest or deal with other matters, thereby helping him to arrange and use his own time reasonably. In addition, if the passenger does not want to wait for the baggage as the baggage will take a relatively long to arrive, he may also require a related service personnel at the airport to convey his baggage to hotel or home, thereby saving his waiting time.

Alternatively, the system may also include an RFID identification tag 23 and a terminal RFID reader 24. The RFID identification tag 23 is provided on the baggage conveyed in the baggage conveying unit 15. When the baggage is conveyed on the conveying belt in the baggage claim zone, the RFID identification tag 23 sends out an RF signal. The terminal RFID reader 24 is provided in the mobile terminal taken along by the passenger. When the terminal RFID reader 24 receives the RF signal sent from the RFID identification tag 23, it will send out an instruction signal indicating that the baggage arrives so that the mobile terminal can locate the baggage when it nears the baggage.

Specifically, the instruction signal indicating that the baggage arrives can be a whistle signal or a vibration signal. When the mobile terminal of the passenger sends the instruction signal indicating that the baggage arrives, he knows that the baggage will arrive soon, and hence can fetch his own baggage on the conveying belt.

The system of the present embodiment enables the passenger to obtain arrival time of his own baggage in time, thereby arranging time reasonably and reducing waiting time.

The ordinary persons skilled in the art can understand that: all or part of the steps of the realization of the abovementioned embodiments of the method can be completed through hardware related to procedure instructions. The aforementioned procedures can be saved in a readable storage medium of computer. When the procedures are carried out, the steps comprising the abovementioned embodiments of the present invention are carried out. The abovementioned storage medium comprises the medium which can store procedure codes, such as ROM, RAM, disks or optical disks, etc.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the scope of the present invention and covered in the claims of the present invention.

What is claimed is:

1. A method for baggage claim at the airport, comprising:
when an RFID claim tag taken along by a passenger gets close to an RFID reader, the RFID reader reading the RFID claim tag and obtaining baggage claim information;
searching corresponding baggage identification information according to the baggage claim information;
searching corresponding baggage according to the baggage identification information; and
conveying the baggage to a designated place according to the baggage claim information.

2. The method of claim 1, wherein the RFID reader is provided at an entry of a baggage claim zone; when the RFID claim tag taken along by the passenger gets close to the entry, the RFID reader reads the RFID claim tag and obtains the baggage claim information.

3. The method of claim 2, wherein after searching the baggage identification information according to the baggage claim information, the method further comprises:
judging whether the baggage to be claimed by the passenger is positioned in the baggage claim zone according to the found baggage identification information; if it is judged that the baggage is positioned in the baggage claim zone, sending out instruction information indicating that the passenger is allowed to enter into the baggage claim zone; otherwise, sending out instruction information indicating that the passenger is refused to enter into the baggage claim zone.

4. The method of claim 1, wherein the step of conveying the baggage to the designated place according to the baggage claim information comprises conveying the baggage to a place where the passenger completes his clearance procedures.

5. The method of claim 1, wherein the step of conveying the baggage to the designated place according to the baggage claim information comprises:
searching connecting information of flight of the passenger according to the baggage claim information;
conveying the baggage to the connecting flight which the passenger is going to take according to the connecting information of the flight.

6. The method of claim 1, wherein the step of conveying the baggage to the designated place according to the baggage claim information comprises:
searching address information pre-stored by the passenger according to the baggage claim information;
conveying the baggage to a corresponding place according to the address information.

7. The method of claim 3, wherein the step of conveying the baggage to the designated place according to the baggage claim information comprises: conveying the baggage to the baggage claim zone according to the baggage claim information.

8. The method of claim 7, wherein before the baggage is conveyed to the baggage claim zone, the method further comprises:
a mobile terminal taken along by the passenger logging on a public service website of the airport;
inputting the baggage claim information into the public service website of the airport;
a website server of the public service website of the airport searching current position information of the corresponding baggage according to the baggage claim information;
determining the expected waiting time according to the current position information of the baggage and sending the expected waiting time to the mobile terminal.

9. The method of claim 7, wherein after the baggage is conveyed to the baggage claim zone, the method further comprises:
when the baggage is conveyed on a conveying belt in the baggage claim zone, a RFID identification tag provided on the baggage sending out an RF signal;
when a terminal RFID reader provided in a mobile terminal taken along by the passenger receives the RF signal, sending out an instruction signal indicating that the baggage arrives.

10. A baggage claim system at the airport, wherein comprising:
an RFID claim tag which is taken along by a passenger;
an RFID reader which is used for reading the RFID claim tag and obtaining baggage claim information;
an information searching unit which is used for searching corresponding baggage identification information according to the baggage claim information read by the RFID reader;
a baggage searching unit which is used for searching corresponding baggage according to the baggage identification information found by the information searching unit; and
a baggage conveying unit which is used for conveying the baggage to a designated place according to the baggage claim information found by the baggage searching unit.

11. The system of claim 10, wherein the RFID reader is provided at an entry of a baggage claim zone.

12. The system of claim 11, wherein the system further comprises a confirmation unit which is used for judging whether the baggage which is to be claimed by the passenger according to the baggage identification information found by the information searching unit is positioned at the baggage claim zone or not; if it is judged that the baggage is positioned in the baggage claim zone, sending out instruction information indicating that the passenger is allowed to enter into the baggage claim zone; otherwise, sending out instruction information indicating that the passenger is refused to enter into the baggage claim zone.

13. The system of claim 10, wherein the system further comprises:
a mobile terminal which is taken along by the passenger and used for logging on a website server of a public service website of the airport before the baggage is conveyed to the baggage claim zone by the baggage conveying unit, and used for inputting the baggage claim information to the website; and
a website server which is used for searching current position information of corresponding baggage from the baggage conveying unit according to the baggage claim information from the mobile terminal, and used for determining expected waiting time according to the current position information of the baggage and sending the expected waiting time to the mobile terminal.

14. The system of claim 10, wherein the system further comprises:
an RFID identification tag which is provided on the baggage and used for sending out an RF signal; and
a terminal RFID reader which is provided in the mobile terminal taken along by the passenger and used for sending out an instruction signal when receiving the RF signal sent out by the RFID identification tag.
